(19) United States
(12) Patent Application Publication
(10) Pub. No.: US 2026/0138281 A1
(43) Pub. Date: May 21, 2026

(54) System, Processing Apparatus, Use of a System and Method for a Gesture-Based Control of an Industrial Robot Comprising a Movable Section

(71) Applicant: SICK AG, Waldkirch (DE)

(72) Inventors: Patrick ERLEWEIN, Vörstetten (DE); Max FRANZ, Oberried (DE)

(21) Appl. No.: 19/387,887

(22) Filed: Nov. 13, 2025

(30) Foreign Application Priority Data
Nov. 15, 2024 (DE) 102024133528.9

(51) Int. Cl. B25J 9/16; B25J 11/00; B25J 13/08

(52) U.S. Cl. CPC B25J 9/1697; B25J 9/1664; B25J 11/0005; B25J 13/089

(57) ABSTRACT

The invention relates to a system for controlling an industrial robot, said system comprising the industrial robot, wherein the industrial robot comprises a movable section; at least one optoelectronic sensor, wherein the optoelectronic sensor is attached to the movable section of the industrial robot and is configured to detect a monitored zone in an environment of at least the movable section of the industrial robot and to obtain data about the monitored zone in so doing, in particular to measure said data by means of time-of-flight methods; and a processing apparatus that is configured to recognize, in the obtained data about the monitored zone, a gesture performed in the monitored zone by at least one object, in particular by an operator, and to trigger a control of the industrial robot in accordance with the recognized gesture.

The invention relates to a system, a processing apparatus, a use of a system and a method for a gesture-based control of an industrial robot comprising a movable section.

In order, for example, to confirm or cancel machine actions of an industrial robot, the input of control signals by the user may be necessary, which can reduce the user's attention to the point of intervention (e.g. the workbench and/or the workpiece) and consequently the productivity. The provision of conventional operating elements, such as buttons, levers or touch panels, can lead to higher costs. Furthermore, the hardware components of the conventional operating elements can present additional obstacles on the workbench and can be perceived as disturbing by the operator.

Furthermore, a plurality of separate operating elements may be required in conventional systems if inputs at different positions and/or different types of inputs are required. On a change to the application (e.g. to the action executed or to be executed by the industrial robot), a laborious adaptation of the operating elements or the addition of further operating elements may be required. Furthermore, conventional systems are often not intuitive for the operator, in particular in the case of more complex sequences of control processes.

It is the underlying object of the invention to make the control of an industrial robot more flexible, more efficient and/or more intuitive for the operator.

A system for controlling an industrial robot having the features of claim 1 is provided to satisfy the object.

The system according to the invention for controlling an industrial robot comprises the industrial robot, wherein the industrial robot comprises a movable section; and at least one optoelectronic sensor, wherein the optoelectronic sensor is attached to the movable section of the industrial robot and is configured to detect (in particular to monitor) a monitored zone in an environment of at least the movable section of the industrial robot and to obtain data about the monitored zone in so doing, in particular to measure said data by means of time-of-flight methods. The system further comprises a processing apparatus that is configured to recognize, in the obtained data about the monitored zone, a gesture performed in the monitored zone by at least one object, in particular by an operator, and to trigger a control of the industrial robot in accordance with the recognized gesture.

In other words, the invention is based on the idea of using sensors, which are present at the movable section of the industrial robot and which are moved along with it, for the control of the industrial robot based on the recognition of gestures. In accordance with the recognized gesture, a command can, for example, be issued by the processing apparatus and is transmitted to the industrial robot (or its control) and executed by the industrial robot. The optoelectronic sensor as interfaces for operating the industrial robot or as an operating element is automatically taken along with the movable section of the industrial robot and consequently with the workpiece. No further operating elements distributed across the working region of the industrial robot are required, which increases the efficiency. Furthermore, different commands can be entered by executing different gestures via a standardized interface, which can make the handling easier for the operator without limiting the functionality of the system in so doing. Changes to the application can be made flexibly (e.g. by changing the parameterization) and without changing the hardware. In particular, new gestures can be taught for new commands or already defined gestures can be adapted. This can allow new applications or actions to be carried out with the industrial robot without having to replace the hardware of the operating elements. The input by the operator can take place directly at the point of intervention and intuitively by means of the execution of gestures, which can make the handling easier and more comfortable for the operator, which can interfere less with the user's attention on the point of intervention (i.e. the workbench and/or the workpiece) or not at all, and which can consequently increase the productivity. Overall, the human-machine interaction can be improved.

The object can be an operator, in particular one hand or both hands of the operator, or also a robot, for example.

The processing apparatus can be configured to trigger a movement of the industrial robot in accordance with a movement of the operator.

The processing apparatus can be in a wireless or wired signal connection with the industrial robot and can send a control signal to a control of the industrial robot in accordance with the recognized gesture. Additionally or alternatively, the processing apparatus can control the industrial robot directly.

The processing apparatus can be present as a separate unit, can be part of the optoelectronic sensor, can be part of the industrial robot, can be provided by the optoelectronic sensor and/or can be provided by the industrial robot. The processing apparatus can also be provided, in whole or in part, by a remote server. The processing apparatus can be in a wireless or wired signal connection with the optoelectronic sensor. The processing apparatus can comprise a processor or a microprocessor. The processing apparatus can comprise and/or access common means (in particular algorithms) for gesture recognition. Such means for gesture recognition are generally known. For example, the processing apparatus can use known algorithms for recognizing a gesture from 2D coordinates of a movement.

The optoelectronic sensor can comprise a light transmitter and a light receiver. Transmission light can be generated by the light transmitter that is coupled to and/or controlled by the light receiver and that is transmitted into the monitored zone, in particular in the form of at least one monitoring beam and/or measuring beam. The light receiver can receive transmission light remitted by the monitored zone (in particular by objects in the detection zone) as reception light and can measure data about the monitored zone, in particular distance values (relative to the optoelectronic sensor) of objects in the monitored zone, based on the received reception light by means of time-of-flight methods.

The movable section of the industrial robot preferably comprises a robot tool. The movable section can comprise a robot arm or can be part of a robot arm. The industrial robot can also comprise more than one movable section, i.e., for example, two, three or more movable sections, wherein only certain or all movable sections can be equipped with an optoelectronic sensor.

It is understood that other functions can also be triggered based on the gesture recognition, such as the output of a signal (in particular a warning signal), the sending of a notification (e.g. to a display device for another operator) and/or the control of another industrial robot.

According to one embodiment, the optoelectronic sensor comprises a laser scanner. Additionally or alternatively, the optoelectronic sensor can comprise a radar sensor, an ultrasonic sensor, a 3D camera or other.

The optoelectronic sensor can comprise an end-of-arm safeguard sensor or can be an end-of-arm safeguard sensor.

According to one embodiment, the optoelectronic sensor comprises a safety sensor. In other words, a safety sensor present at the industrial robot can be reused for the gesture recognition. In this way, the components of the system can be used twice and thus more efficiently. Alternatively, the optoelectronic sensor can be configured solely, i.e. in a dedicated manner, for a gesture recognition.

A protective field is preferably created in the optoelectronic sensor and a safety-related signal is output if said protective field is violated. In this respect, the terms safe or safety used herein can be understood within the meaning of certain safety-specific standards, such as ISO 13849 or IEC 62998. The safety-related signal can comprise a warning signal to the operator and/or can trigger a transfer of the industrial robot to a safeguarded control mode. The processing apparatus can be configured, when a protective field violation is recognized without recognizing a gesture, to trigger the output of a safety-related signal. Additionally or alternatively, the region in which the gesture is performed can be cut out of the protective field.

According to one embodiment, the monitored zone detected by the optoelectronic sensor is directed away from the movable section of the industrial robot. In other words, the field of view of the sensor points away from the movable section of the industrial robot. In this way, it can be ensured and/or facilitated that the gesture performed in the vicinity of and/or at the point of intervention at which e.g. the workpiece is located can be recognized.

According to one embodiment, the orientation of the monitored zone is substantially parallel to or identical to the orientation of the movable section. In other words, the monitored zone can be viewed as an “extension” of the movable section. In this way, it can be ensured and/or facilitated that the gesture performed in the vicinity of and/or at the point of intervention at which e.g. the workpiece is located can be recognized.

According to one embodiment, the gesture comprises a movement of the object, in particular of the operator, and preferably a hand movement of the operator.

According to one embodiment, the gesture by the object, in particular the operator, can be taught.

According to one embodiment, the gesture is defined as a reaching into the monitored zone at a position, a reaching out of the monitored zone at a position, a movement between two positions within the monitored zone, a tracing of a predetermined path within the monitored zone, a clenching of a fist, an opening of a fist, a crossing of the arms, a lateral swipe, a swipe towards the sensor, a swipe away from the sensor, a movement of the outstretched arms and/or a movement of the hand towards the sensor and/or a movement of the outstretched arms and/or a movement of the hand away from the sensor.

According to one embodiment, the gesture is defined as a combination of a plurality of movements.

According to one embodiment, a linear movement of the object, in particular a hand movement of the operator, to the side, upwards, downwards or along a diagonal, triggers a corresponding movement of the industrial robot. In other words, the industrial robot can follow the hand movement of the operator.

According to one embodiment, a movement of the object, in particular a hand movement of the operator, along a (substantially closed) ellipse or a (substantially closed) circle triggers a repetition of an action executed by the industrial robot and/or of an action planned for the execution by the industrial robot.

According to one embodiment, the forming of a cross with a movement of the object, in particular with a hand movement of the operator, triggers the cancellation of the action executed by the industrial robot and/or the deletion of the action planned for the execution by the industrial robot. The forming of a cross can mean a sequence of linear movements along the vertical (e.g. in the y direction), the diagonal (e.g. in the xy plane) and the horizontal (e.g. in the x direction) or in a reverse sequence.

According to one embodiment, the substantially simultaneous movement of two objects, in particular of both hands of the operator, out of the monitored zone triggers a confirmation of a completion of the action executed by the industrial robot and/or of the action planned for the execution by the industrial robot. The industrial robot is preferably configured, in response to the confirmation of the completion, to change its speed of movement (i.e. to slow down or speed up), to stop the execution of the action, to start the execution of another action or to move into a stop position.

According to one embodiment, the processing apparatus is configured to recognize the gesture based on at least one determined distance value of a movement of the object, in particular of the operator. Additionally or alternatively, the monitored zone comprises at least one detection zone and the processing apparatus is configured to recognize the gesture based on a detection of the object, in particular of the operator (and preferably of his hand), in a specific detection zone of the monitored zone and/or based on a sequence of detections of the object, in particular of the operator (and preferably of his hand), in specific detection zones of the monitored zone. For example, a detection or non-detection can be saved as true or false information (e.g. as 1 or 0) in a list. In addition or alternatively, each detection zone can be assigned an identifier. If the object is detected, the identifier of the respective detection zone can be saved in a list. The gesture can then be determined based on the sequence of the true/false information and/or identifiers stored in the list. The detection zones (and in additional also certain regions around them) can be cut out of a protective field of the optoelectronic sensor.

According to one embodiment, the system, and in particular the processing apparatus, comprises a display device, preferably augmented reality glasses, that is configured to indicate the successful recognition of the gesture to the operator, for example, by the output of a light signal or a color change of a visualized geometric shape. Additionally or alternatively, the display device is configured to visualize the monitored zone, at least one detection zone in the monitored zone and/or a path to the operator, preferably in an augmented reality view, as at least one geometric shape. In addition or alternatively, the display device can comprise at least one LED (preferably a series of LEDs) that is (or are) arranged at the (in particular in a ring shape around the) movable section of the industrial robot.

According to one embodiment, the display device is configured to visualize at least two detection zones of the monitored zone to the operator, wherein the detection zones are preferably indicated for the operator by at least one number, by at least one symbol (e.g. an arrow, a star, an animal image, a line or the like), by at least one letter and/or in color, wherein the number, the symbol, the letter and/or the color (e.g. the color design, in particular a color development) indicates/indicate the sequence of the detections to be triggered in the detection zones for the execution of the gesture.

According to one embodiment, the monitored zone is limited by monitoring beams transmitted only at an outer boundary, wherein the outer boundary is preferably ring-shaped. The measuring beams can consequently envelop the movable section (which e.g. comprises a robot tool and/or a gripper) and can thus secure it as a protective jacket. For example, distance sensors are arranged in a ring shape for this purpose. Their measuring beams can have an angle of incidence.

According to one embodiment, the monitored zone comprises a two-dimensional space, preferably a three-dimensional space, wherein the gesture is preferably defined as a movement of the object, in particular of the operator, in two dimensions, preferably three dimensions.

A further subject of the invention is a processing apparatus described herein for controlling an industrial robot comprising a movable section.

A further subject of the invention is the use of a system described herein for controlling an industrial robot comprising a movable section.

A further subject of the invention is a method for controlling an industrial robot comprising a movable section, wherein the movable section preferably comprises a robot tool, wherein a monitored zone in an environment of at least the movable section of the industrial robot is detected (in particular monitored) by means of an optoelectronic sensor attached to the movable section and data about the monitored zone are obtained in so doing, in particular measured by means of time-of-flight methods; wherein a gesture performed by at least one object, in particular by an operator, in the monitored zone is recognized in the obtained data about the monitored zone; and wherein a control of the industrial robot is triggered in accordance with the recognized gesture.

It is understood that what is described with respect to the system according to the invention also applies to the processing apparatus, to the use of the system and to the method. This in particular applies to embodiments and advantages. Furthermore, it is to be understood that all the features and embodiments disclosed herein can be combined unless expressly stated otherwise.

The invention will be described in the following purely by way of example with reference to possible embodiments and to the enclosed drawing. There are shown:

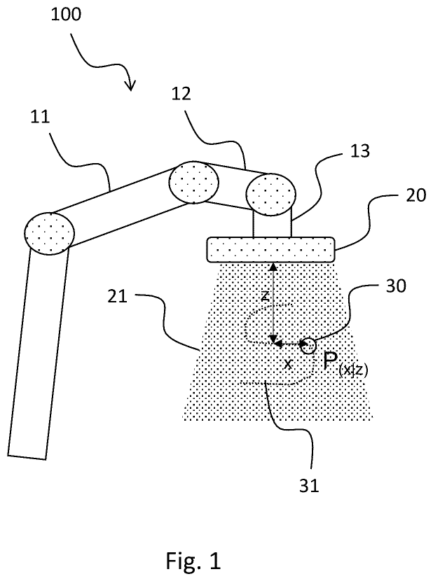

FIG. 1 a schematic representation of a system for controlling an industrial robot comprising a movable section; and

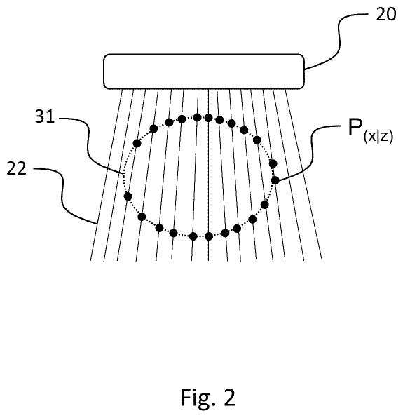

FIG. 2 a schematic representation of the optoelectronic sensor of the system in FIG. 1.

FIG. 1 schematically shows a system 100 for controlling an industrial robot comprising at least one movable section, wherein the industrial robot shown in FIG. 1 comprises a first, second and third movable section 11, 12, 13. It is understood that the industrial robot can also comprise fewer or more than three movable sections, i.e., for example, only one movable section or also four, five or more movable sections.

The system 100 in FIG. 1 comprises the industrial robot and at least one optoelectronic sensor 20, wherein the optoelectronic sensor 20 is attached to the third movable section 13 of the industrial robot and is configured to detect a monitored zone 21 in an environment of at least the third movable section 13 of the industrial robot and to obtain data about the monitored zone 21 in so doing, in particular to measure said data by means of time-of-flight methods. The third section 13 can comprise a robot tool, in particular a gripper. The system 100 further comprises a processing apparatus (not shown in FIG. 1) that is configured to recognize, in the obtained data about the monitored zone 21, a gesture performed in the monitored zone 21 by at least one object 30, in particular by an operator, and to trigger a control of the industrial robot in accordance with the recognized gesture. In this way, the optoelectronic sensor 20, which is present at the movable section 13 of the industrial robot and can be moved along with it, can be used for the control of the industrial robot based on the recognition of gestures. In accordance with the recognized gesture, a command can, for example, be issued by the processing apparatus (not shown in FIG. 1) and is transmitted to the industrial robot (or its control which is not shown in FIG. 1) and is executed by the industrial robot.

The monitored zone 21 can comprise a two-dimensional space, and preferably a three-dimensional space, wherein the gesture can be defined as a movement of the object 30, in particular of a hand of the operator, in two dimensions (e.g. in an xy plane, yz plane or xz plane), preferably three dimensions (e.g. in an xyz coordinate system). The data about the monitored zone can comprise distance values of the object 30 (e.g. viewed relative to the optoelectronic sensor) and can be specified, for example, in x, y and/or z coordinates or converted into x, y and/or z coordinates. As shown in FIG. 1, the position of the object 30, while it moves on a path 31 in the monitored zone 21, can be detected as an xz coordinate value P_{(x|z)}. The detection of the position of the object 30 as a yz coordinate value P_{(y|z)}, an xy coordinate value P_{(x|y)} or as an xyz coordinate value P_{(x|y|z)} is also possible, for example.

The gesture can be defined as a reaching into the monitored zone 21 at a position, a reaching out of the monitored zone 21 at a position, a movement between two positions within the monitored zone 21, a tracing of a predetermined path 31 within the monitored zone 21, a clenching of a fist, an opening of a fist, a crossing of the arms, a lateral step, a step towards the sensor 20, a step away from the sensor 20, a movement of the outstretched arms and/or a movement of the hand towards the sensor 20 and/or a movement of the outstretched arms and/or a movement of the hand away from the sensor 20. The gesture can be defined as a combination of a plurality of movements. As shown in FIG. 1, the movement of the object 30 along the path 31 can be parameterized or traced as a plurality of detected positions or coordinate values P.

Example gestures with an associated movement and a corresponding command are listed in Table 1. According to example 1, a linear movement of the object 30 to the side, upwards, downwards or along a diagonal triggers a corresponding movement of the industrial robot. According to example 2, a movement of the object 30 along a (substantially closed) ellipse or a (substantially closed) circle triggers a repetition of an action executed by the industrial robot and/or of an action planned for the execution by the industrial robot. According to example 3, the forming of a cross with a movement of the object 30 triggers the cancellation of the action executed by the industrial robot and/or the deletion of the action planned for the execution by the industrial robot. Forming a cross can mean a sequence of linear movements along a vertical (e.g. in the z direction or y direction), a diagonal (e.g. in the xy plane or in the xz plane) and a horizontal (e.g. in the x direction) or in the reverse sequence. According to example 4, the substantially simultaneous movement of two objects 30, in particular of both hands of the operator, out of the monitored zone 21 triggers a confirmation of a completion (i.e. “done” or “executed”) of the action executed by the industrial robot.

TABLE 1

| Example | | |
|---|---|---|
| gesture | Movement | Command |
| 1 | Linear movement (upwards, | Machine |
| | downwards, right, left, diagonal) | movement |
| 2 | Movement along a circle or an ellipse | Repetition |
| 3 | Cross-forming movement | Cancellation |
| 4 | Simultaneous outward movement of | Confirmation |
| | both hands out of the monitored zone | “Executed” |

As is shown in FIG. 1, the monitored zone 21 detected by the optoelectronic sensor 20 is oriented away from the third movable section 13 of the industrial robot. As can be seen in FIG. 1, the orientation of the monitored zone 21 can be substantially parallel to or identical to the orientation of the third movable section 13 (here in the z direction). In this way, it can be ensured and/or facilitated that the gesture performed in the vicinity of and/or at the point of intervention at which e.g. a workpiece is located can be recognized.

As is schematically shown in FIG. 2, the optoelectronic sensor 20 can comprise a laser scanner that emits transmission light in the form of a plurality of monitoring beams 22 into the monitored zone. The transmission light of the monitoring beams 22 can be remitted (and in particular reflected) by the object 30 while it moves on the path 31 and can be reflected back to the optoelectronic sensor 20 as reception light. The optoelectronic sensor 20 can then measure distance values of the object (relative to the optoelectronic sensor 20) based on the received reception light by means of time-of-flight methods. As shown in FIG. 2, a coordinate value, for example P_{(x|z)}, can be obtained, for example, for each point of intersection of the object 30 with one of the monitoring beams 22 on its path 31 through the monitored zone 21. In this way, the movement of the object 30 on the path 31 can be tracked and the gesture can be recognized. The tracked path 31 shown in FIG. 2 is circular or elliptical, which corresponds to the example gesture 2 from Table 1 and consequently triggers a repetition of an action executed by the industrial robot and/or of an action planned for the execution by the industrial robot.

### REFERENCE NUMERAL LIST

11 first movable section
12 second movable section
13 third movable section
20 optoelectronic sensor
21 monitored zone
22 monitoring beams
30 object
31 path
100 system

1. A system for controlling an industrial robot, the system comprising

2. The system of claim 1, wherein the optoelectronic sensor comprises a laser scanner.

3. The system of claim 1, wherein the monitored zone detected by the optoelectronic sensor is directed away from the movable section of the industrial robot.

4. The system of claim 1, wherein the gesture comprises a movement of the object.

5. The system of claim 4, wherein the gesture is selected from the group consisting of: reaching into the monitored zone at a position; reaching out of the monitored zone at a position; a movement between two positions within the monitored zone; tracing of a predetermined path within the monitored zone; clenching of a fist; opening of a fist; crossing of the arms; a lateral swipe; a swipe towards the sensor; a swipe away from the sensor; a movement of outstretched arms and/or a movement of the hand towards the sensor; and a movement of outstretched arms and/or a movement of the hand away from the sensor.

6. The system of claim 4, wherein

[symbol]

7. The system of claim 6, wherein, in response to the confirmation of the completion, the industrial robot changes its speed of movement, stops the execution of the action, starts the execution of another action or moves into a stop position.

8. The system of claim 1, wherein the processing apparatus is configured to recognize the gesture based on at least one determined distance value of a movement of the object.

9. The system of claim 1, wherein the monitored zone comprises at least one detection zone and the processing apparatus is configured to recognize the gesture based on a detection of the object in a specific detection zone of the monitored zone and/or based on a sequence of detections of the object in specific detection zones of the monitored zone.

10. The system of claim 1, comprising a display device configured to indicate the successful recognition of the gesture to the operator and/or to visualize the monitored zone, at least one detection zone in the monitored zone and/or a path to the operator as at least one geometric shape.

11. The system of claim 10, wherein the display device is configured to visualize at least two detection zones of the monitored zone to the operator.

12. The system of claim 1, wherein the monitored zone is limited by monitoring beams transmitted only at an outer boundary.

13. A processing apparatus for controlling an industrial robot having a movable section, the processing apparatus being configured to recognize, in data about a monitored zone detected by an optoelectronic sensor attached to the movable section, a gesture performed in the monitored zone by at least one object, and to trigger a control of the industrial robot in accordance with the recognized gesture.

14. The processing apparatus of claim 13, wherein the processing apparatus is configured to recognize the gesture based on at least one determined distance value of a movement of the object.

15. The processing apparatus of claim 13, wherein the monitored zone comprises at least one detection zone and the processing apparatus is configured to recognize the gesture based on a detection of the object in a specific detection zone of the monitored zone and/or based on a sequence of detections of the object in specific detection zones of the monitored zone.

16. The processing apparatus of claim 13, further comprising a display device configured to indicate the successful recognition of the gesture to the operator and/or to visualize the monitored zone, at least one detection zone in the monitored zone and/or a path to the operator as at least one geometric shape.

17. The processing apparatus of claim 16, wherein the display device comprises augmented reality glasses.

18. The processing apparatus of claim 16, wherein the visualization is in an augmented reality view.

19. A method for controlling an industrial robot having a movable section, the method comprising

[symbol]

20. The method of claim 19, wherein the movable section comprises a robot tool.
